(19) United States
(12) Patent Application Publication
(10) Pub. No.: US 2009/0037341 A1
(43) Pub. Date: Feb. 5, 2009

(54) Method and System for On-line Sales

(76) Inventor: Dale Underwood, Ijamsville (MD)

Correspondence Address: MILES & STOCKBRIDGE PC, 1751 PINNACLE DRIVE, SUITE 500, MCLEAN, VA, 22102-3833, US

(21) Appl. No.: 12/184,336

(22) Filed: Aug. 1, 2008

Related U.S. Application Data
(60) Provisional application No. 60/953,353, filed on Aug. 1, 2007.

(51) Int. Cl. G06Q 30/00; G06Q 10/00

(52) U.S. Cl. 705/80; 705/400; 705/27

(57) ABSTRACT

Embodiments of the present invention relate to a system and software methods employed by a web-based system that facilitates business to business buyer and seller interaction, and more particularly to a system to fix a long-standing disconnect between corporate buyers and sellers that helps manufacturers engage with prospective business customers by providing “self-service pricing” for their products and services. In accordance with an embodiment of the present invention, a method of providing electronic price quotes includes receiving a request to prepare a price quote on a product or service offered by a seller; preparing a price quote for the product or service; communicating the price quote for approval; receiving approval of the price quote; and communicating the approved price quote in response to the request to prepare the price quote to a source of the request and to at least an approver of the price quote.

### CROSS-REFERENCE TO RELATED APPLICATIONS

This application claims benefit of priority to U.S. Provisional Patent Application No. 60/953,353, filed Aug. 1, 2007 and which is herein incorporated in its entirety by reference.

### FIELD OF THE INVENTION

Embodiments of the present invention relate to a system and software methods employed by a web-based system that facilitates business to business buyer and seller interaction, and more particularly to a system to fix a long-standing disconnect between corporate buyers and sellers that helps manufacturers engage with prospective business customers by providing “self-service pricing” for their products and services.

### BACKGROUND

Although the Internet has been a boon to businesses and individuals alike, its integration into how buyers (e.g., but not limited to, retail customers, business customers, and the like) and sellers (e.g., but not limited to, individuals, businesses, and the like), it has inverted the role of buyers and sellers. Specifically, as seen in FIG. 1, pre-Internet marketing was controlled by a manufacturer/seller 110 of a product or service 112. The manufacturer generally had a marketing group/department/function/organization 114 that used outbound marketing techniques 120 such as advertising to reach prospective business customers 130. As used herein, group, department, function, and/or organization may be used interchangeably to refer to a specific functional, or other type, of entity within a business and/or organization. Examples of specific media include magazine, television, radio and direct mail advertisements. Information flow was one-way, that is, from the seller 110 to the prospective buyer 130.

Upon viewing or receiving the advertisements, as shown in FIG. 2, prospective business customers 130 would then contact the manufacturer's sales group 216 and request more information. The seller's sales group 216 would then handle the sales process from inception to close. In some cases, resellers (dealers) 220 may also act in conjunction with or as the sales group 216.

Then came the Internet. The introduction of the Internet changed the way these disparate groups interact. As shown in FIG. 3, the marketing group 114 is now empowered to publish sales content directly out to the web on content-rich websites 310. This content may include brochures 312, whitepapers 314, and webinars 316. The sales team 216 even encourages customers 130 to “visit the website” for any information they need. Since prospective customers 130 can get information from the websites 310 anonymously, the sales group 216 is left out of the process.

FIG. 4 illustrates how search utilities 405 like Google and Yahoo are compounding the problem. The prospective customers 130 not only bypass the manufacturer's sales group 216 but they actively seek information from other manufacturer's websites 420 as well. Competing marketing groups striving for attention continue the vicious circle of publishing even richer content (whitepapers, video, free trials) to an increasingly indifferent and detached prospect. As a result, the prospect has become a “hunter” of information unwilling to engage a sales team about its products or services.

In summary, manufacturers have lost control of the sales process, because the Internet has empowered the prospect. Therefore, the Prospective Business Customer is now in charge of the sales process because the customer decides when and where he or she will retrieve information and is able to do so anonymously. This creates a problem for manufacturers that need prospect interaction to convey their value and sell their products.

### SUMMARY

Some embodiments of the present invention pertain to systems and software methods employed by a web based system that facilitates business to business buyer and seller interaction. The system was designed and implemented to fix a long-standing disconnect between corporate buyers and sellers. The system helps manufacturers engage with prospective business customers by providing “self-service pricing” for their products and services.

### BRIEF DESCRIPTION OF THE DRAWINGS

Non-limiting and non-exhaustive embodiments of the present invention are described with reference to the following figures, wherein like reference numerals refer to like parts throughout the various views unless otherwise precisely specified.

FIG. 1 is a functional process diagram of how a traditional marketing program controlled the information given to prospective customers.

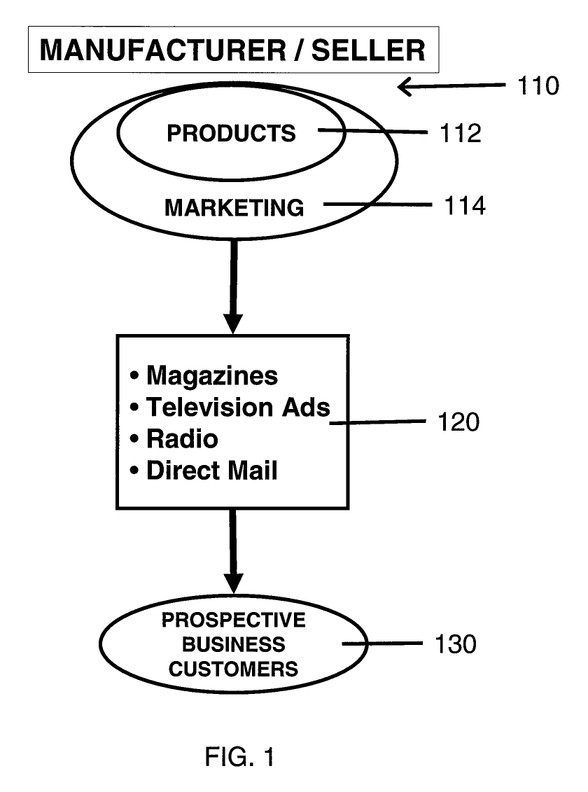

FIG. 2 is a functional process diagram of a traditional process of how a prospect that wanted more information had to go through a seller's sales group or a reseller.

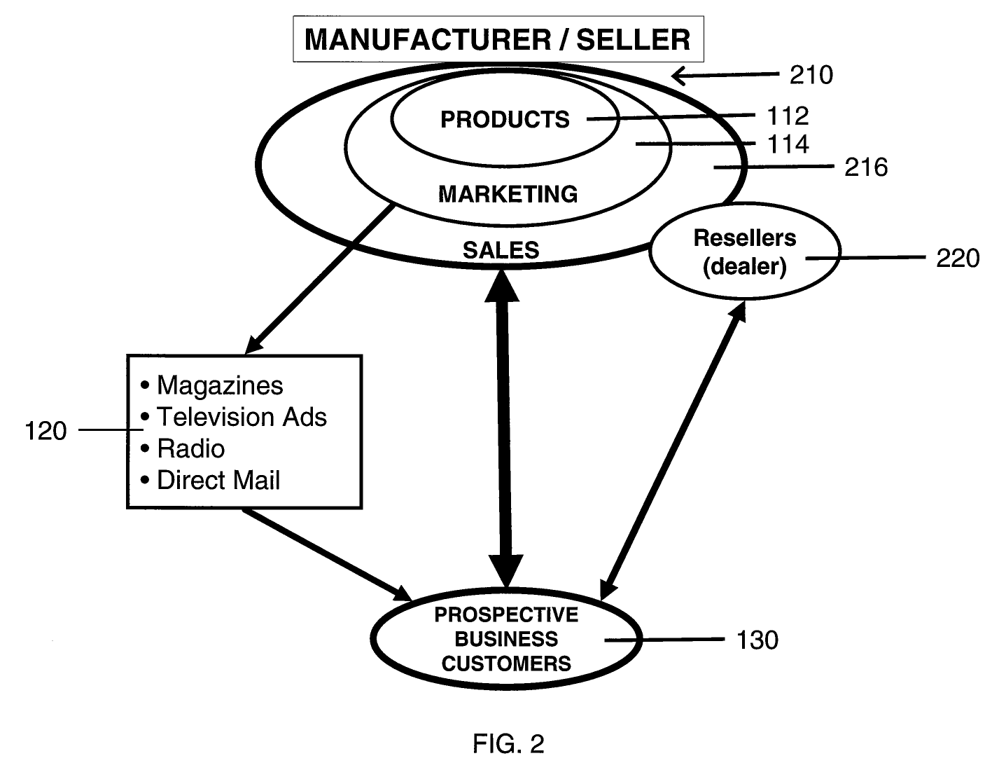

FIG. 3 is a functional process diagram of the functioning of traditional content rich websites created by marketing that have reduced the dependence on the sales group.

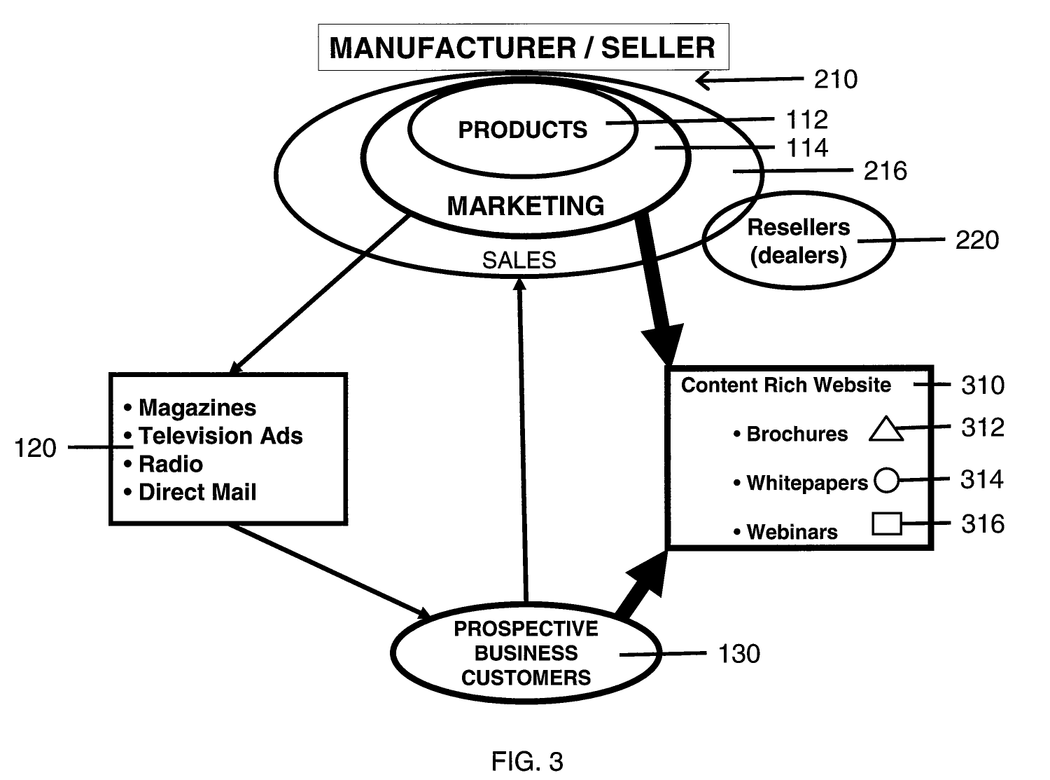

FIG. 4 is a functional process diagram of an implementation of how Google has turned prospects into perpetual searchers, even for competition.

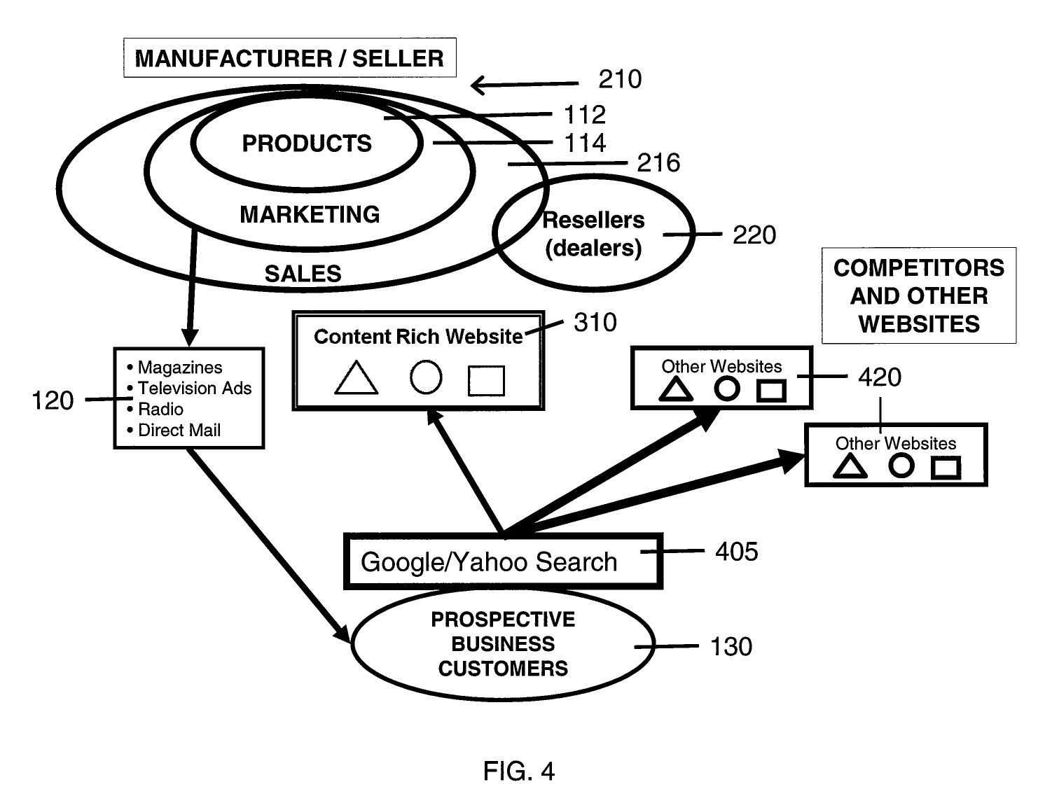

FIG. 5 is a functional process diagram of an implementation of how pricing is one of the strongest (and last) incentives available to engage the prospect, in accordance with an embodiment of the present invention.

FIG. 6 is a functional process diagram of how system processes run in the background, out of view from the prospective customer, in accordance with an embodiment of the present invention.

FIG. 7 is a flow diagram of a how a backend portion of the system manages approvals and quote delivery, in accordance with an embodiment of the present invention.

FIG. 8 is a flow diagram of how third parties can be used to manage quote approval and delivery, in accordance with an embodiment of the present invention.

### DESCRIPTION OF VARIOUS EMBODIMENTS OF THE INVENTION

In accordance with one or more embodiments of the present invention, a system, which may include software-implemented methods, may be embodied in a web based system to facilitate business to business buyer and seller interaction. The system helps manufacturers engage with prospective business customers by providing “self-service pricing” for their products and services.

While sales prospects generally have no trouble getting product information, there is one vital piece that is generally NOT available on the manufacturer's websites, pricing. There are many reasons why manufacturers do not put pricing on their websites including:
There is no way to identify the identity of the requestor (e.g., it could be a competitor that the manufacturer does not want to have the pricing information);
Different channels (and customers) get different pricing;
Web pricing would allow the sales prospect (i.e., the requester) to bypass the sales team even more;
Solution configurations are frequently complex and/or detailed, and not always easily configured by the sales prospect using the manufacturer's website; and
The sales and marketing group doesn't have the IT resources to properly address the issue.
   Therefore, there is an opportunity for manufacturers to engage the prospect by using the promise of pricing as the incentive. As used herein, prospect, sales prospect, requester, and customer may be used interchangeably to refer to any individual accessing a website for information related to purchasing a product and/or service from the website. Most prospects want to get an idea of how much a product will cost as soon as possible to determine if it is within their budget. If they cannot find the price easily they will quickly abandon the website in search of “market price” somewhere on the Internet. This is the exact point where embodiments of the present invention may be used to provide the prospect with a Self-Service Price.

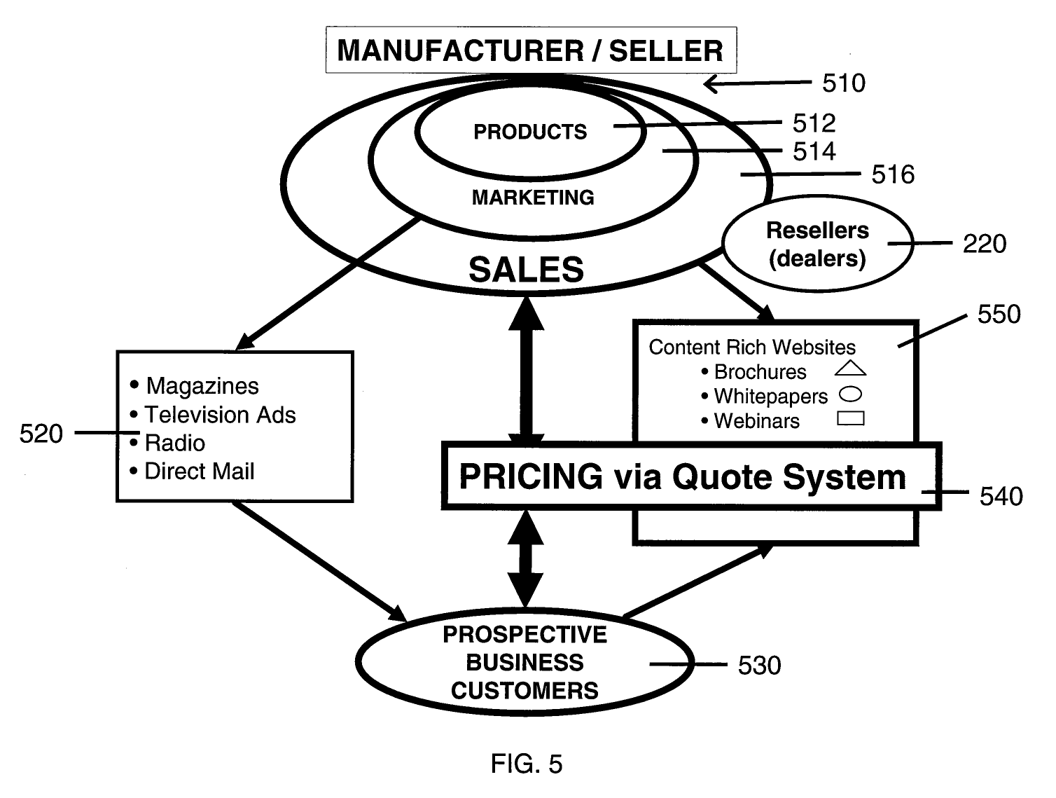

FIG. 5 is a functional process diagram of an implementation of how pricing is one of the strongest (and last) incentives available to engage the prospect, in accordance with an embodiment of the present invention. Using the embodiment of the present invention in FIG. 5 allows the manufacturer to safely provide pricing and engage the Prospective Business Customer. By simply adding the embodiment of the present invention to a manufacturer's website the Sales team is being re-connected to the prospective customer. As seen in FIG. 5, a manufacturer/seller 510 of products and/or services 512 may include a marketing group 514 and a sales group 516. The marketing group 514 may still send out marketing materials 520 to prospective customers 530, who in turn may review the manufacturer/seller's 510 web site 550 for additional information on the products and/or services 512 being offered. For example, the web site 550 may include a variety of content rich documents, including, but not limited to, brochures, whitepapers, webinars, etc. However, when a prospective customer 530 desires pricing information the request for pricing information, i.e., a quote request, is received by a quote system 540 that immediately prepares a quote based on predetermined system inputs. The quote system 540 may send the quote to the sales group 516 for approval and, once the approval is received, then forward the approved quote to the prospective customer 530. Therefore, when prospects request a quote, they can be immediately passed to the sales team for “approval” and/or modification, if required. This process eliminates all of the obstacles faced by manufacturers to provide pricing, as described above. Alternately, the quote system 540 may then send the quote directly to the prospective customer 530 along with sending a notification to the sales group 516, so they can follow up with the prospective customer 530.

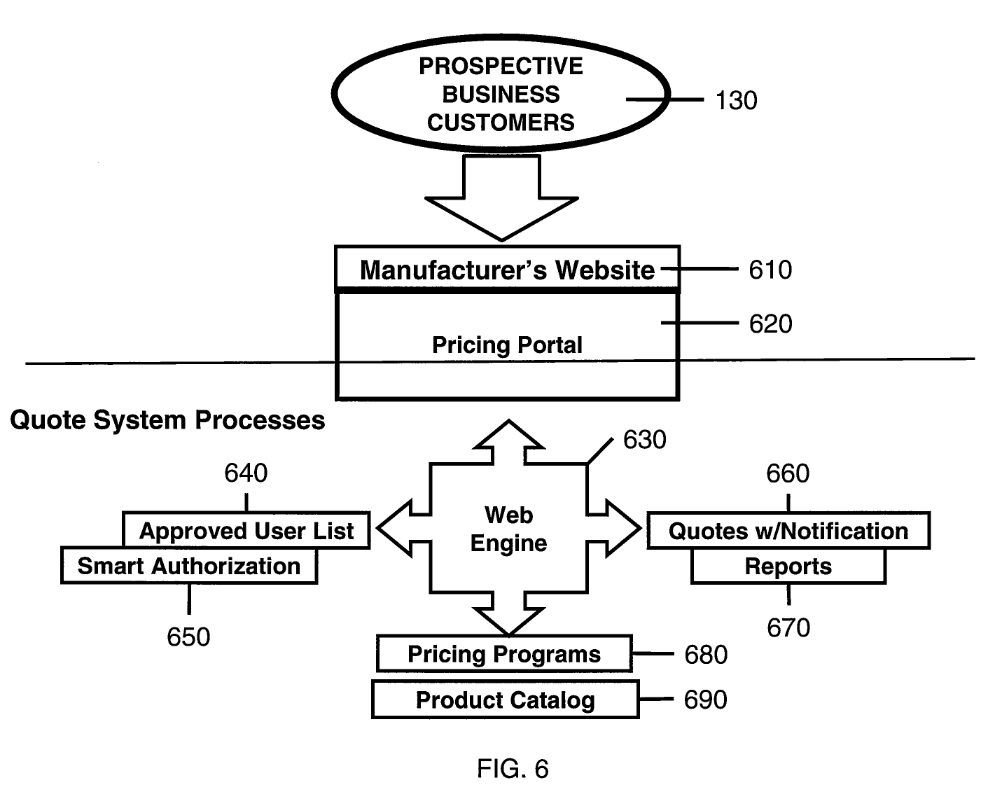

FIG. 6 is a functional process diagram of how system processes run in the background, out of view from the prospective customer, in accordance with an embodiment of the present invention. In FIG. 6, the system now assumes that the prospective customer 130 is in charge and “on top” of the process. The prospective customer 130 may access a system Pricing Portal 620 via a Manufacturer's website 610, generally, this access may be provided via “How to Buy” or “Contact Us” web pages that are normally found on Corporate sites. Once a prospect has clicked on the quote system link, the underlying quote system processes take over.

Web Engine Basics. At the core of quote system is a web engine 630 that includes a set of software programs that handle all quote requests and coordinate sales team notification. A variety of database tables may be used by the program to store user information, quotes and product information. One such table may be an approved user list 640, which may include the names and contact information for users that have previously been approved to receive quotes directly. When a user requests a quote they are asked to supply basic identification information, for example, but not limited to, name, phone number, organization and email address. The system manager has the ability to set additional access controls for each user such as report authorization and quote auto-approvals.

In FIG. 6, the system also may be capable of automatically approving certain types of quote requests using a Smart Authorization component 650. For instance, if a manufacturer has set up a specific pricing program for a major customer then any quote requests from an email address that matches that customer can be approved automatically by the smart authorization component 650. For example, say that a manufacturer does a lot of business with the US Army and wants to improve the level of responsiveness for its Army prospects. The manufacturer can create an “army” Pricing Program and specify that it is to be auto-approved. When a prospect from the Army enters their email address for a quote, the system will recognize “army” and provide that level of pricing automatically; no approval needed. This allows a manufacturer to handle dozens if not hundreds of quote requests per day accurately and quickly. There are several Smart Authorization scenarios provided by the system.

In FIG. 6, a key component of the system is a Pricing Programs function 680 that enables the system to present a custom pricing schedule to the prospective customer 130 based on their email address identity. There are many uses for the Pricing Programs function 680 including, but not limited to, special government pricing, reseller tiered pricing, large customer and large integrator pricing. Each defined price type may have many configurable parameters to tailor the quotes for each specific group with which it may be associated. For example, these parameters may include, but are not limited to: whether the pricing program is active or inactive; the email domain to match for smart authorization; whether the price is based on commercial or government (GSA) pricing; the amount of discount off the base price; a list of approver email addresses; State and Area Code approval request setup; a list of carbon copy email addresses; and quote footer information specific for requesting customer including sales contacts and ordering information.

In addition, in FIG. 6, the list of people to be notified of the prospective customers interest is also based on the specific Pricing Program selected. Once a quote has been requested and approved, the quote is sent automatically back to the prospective customer 130 and any other designated email addresses (manufacturers or 3^{rd} parties). The system can also send a notification based on phone area code or state. This is useful for territory based sales organizations.

In FIG. 6, the system may also include a product catalog 690, which may be custom designed for the system so that, in addition to the basic item number, description and price found in most catalogs, the system product catalog 690 may also group items into pre-configured Product Groups. For example, a system configuration/kit of the specific products needed for the system, as in a desktop computer system designed for Internet access, where the minimum hardware requirements may include a CPU, a monitor, a keyboard, a mouse, a mass memory system, a firewall, and a communications subsystem. This helps prospective customers combine items in a meaningful way to create a complex configuration. Each item also may be designated as Required, Recommended or Optional for the kit giving the customer even more useful advice. The manufacturer may also designate the “recommended quantity” of an item to further aid the prospect.

In FIG. 6, a quote 660 may be produced and delivered that is custom generated based on the Pricing Programs 680 specified. For example, if the quote is for a Government customer, then the quote may contain Government purchasing specific information. This allows a manufacturer to deliver custom information to each targeted prospect group and to deliver a consistent sales message each time.

Integration with Customer Relationship Management (CRM) Systems. As quotes are approved and sent the system has the ability to capture the prospective customer's 130 contact information and populate a CRM system. This enhances a manufacturer's ability to integrate the system with existing Sales Management systems. The information captured and sent may include, but is not limited to, email address, first name, last name, phone number, organization/company and state (if applicable).

Document Distribution. In addition to providing price quote services, the system can also be used to distribute documents for the manufacturer. For instance, some manufacturers may have special “whitepapers” or research documents that they want to provide to prospect customers but control which prospective customers actually receive them, so the manufacturers do not want to publish these documents publicly on their website. The system approval mechanism in embodiments of the present invention gives manufacturers that control while the automation reduces the manufacturer's resources required to manage the distribution.

The system in FIG. 6 is also designed to help manufacturers find and engage more prospective customers. For example, during the quote interaction, basic information is stored about the prospective customer and the items they are requesting. This information is available to the manufacturer through an automated report delivery system 670. A manufacturer's sales and marketing staff can automatically request and receive the reports via email. Reports provided by the automated report delivery system 670 may include, but are not limited to, all quotes requested, pricing programs and contact lists.

Prospective customers 130 may also retrieve from the system in FIG. 6 a report of all of the quotes they have requested over time. This is especially helpful for prospects that get quotes for budgetary purposes early in a project and then need to retrieve a copy of the old quotes. In addition, for major account customers, a central buyer may retrieve all quotes generated for his organization helping them understand the total volume of business being done with the manufacturer.

Therefore, the embodiment of the system in FIG. 6 is provided as a web-based service to connect prospective purchasers of a particular product with the product manufacturer's sales and marketing team. Since the Internet has empowered the prospective business customer to search for his own information the manufacturer's sales and marketing teams are generally left out of the loop. By using the promise of budgetary pricing as an incentive, the system captures a prospective buyer's information and relays that to the sales team instantly. The system may be used in a variety of ways for different business types. For example, manufacturers may use it to help drive new business through multiple sales channels like government, resellers, integrators and major accounts. The system may also be used by Resellers to represent Manufacturers. In all cases, the system has been proven to drive additional business activity.

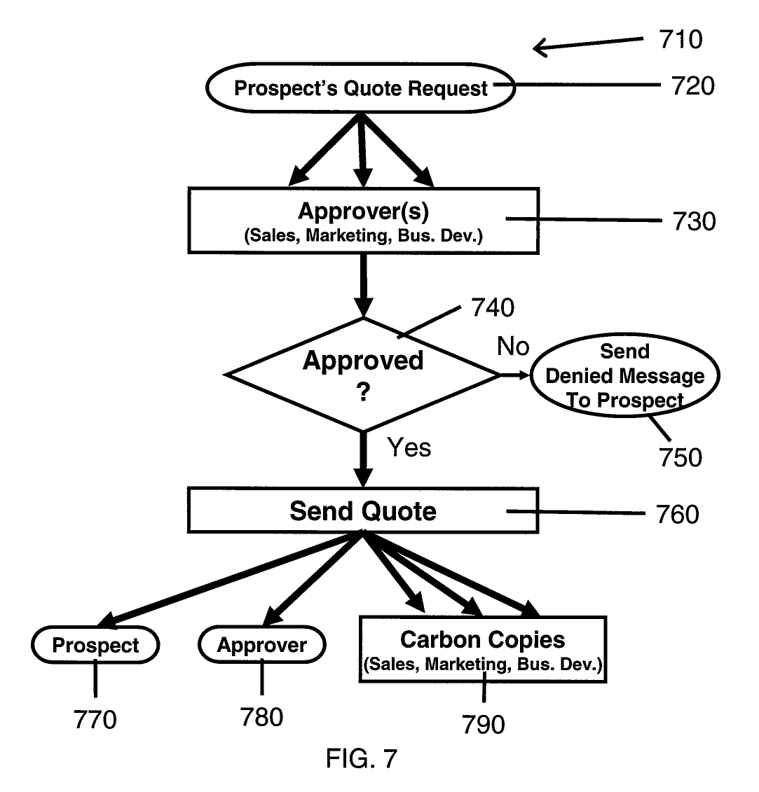

FIG. 7 is a flow diagram of a how a backend portion of the system manages approvals and quote delivery, in accordance with an embodiment of the present invention. In FIG. 7, a Quote Approval Process 710 is shown to include a variety of steps and involvement of several different entities. In general, the quote approval process 710 ensures that only those Prospective Business Customers that are approved by the manufacturer's sales team (or any designated personnel) will receive the pricing information. In FIG. 7, the process flow for receiving and deciding on whether to approve a prospective customer's quote request is shown. Note that not all quote requests will require approval (see Smart Authorization description in FIG. 6), but for those that do the system is designed to handle the requests quickly.

In FIG. 7, the system receives (720) a prospective customer's request for a quote and, if necessary, forwards (730) the quote request to one or more pre-designated approval authorities, for example, but not limited to, a sales manager, a marketing manager, and/or a business development manager. If the request is denied (740), a message to that effect may be sent back to the prospective customer with additional information on what the prospective customer needs to do to obtain an actual quote. For example, this may only require that the user contact the sales team directly to receive quotes. If the request is approved (740), the quote may be sent (760) to the prospective customer 770 with all of the necessary details and information for the prospective customer to finalize the purchase. In addition, the quote may be sent (760) to the person and/or entity that approved (740) the quote and copies may also be sent (760) to the other potential approvers that were not actually involved in the approval. For example, the quote also may be sent to the sales manager, the marketing manager, and/or the business development manager.

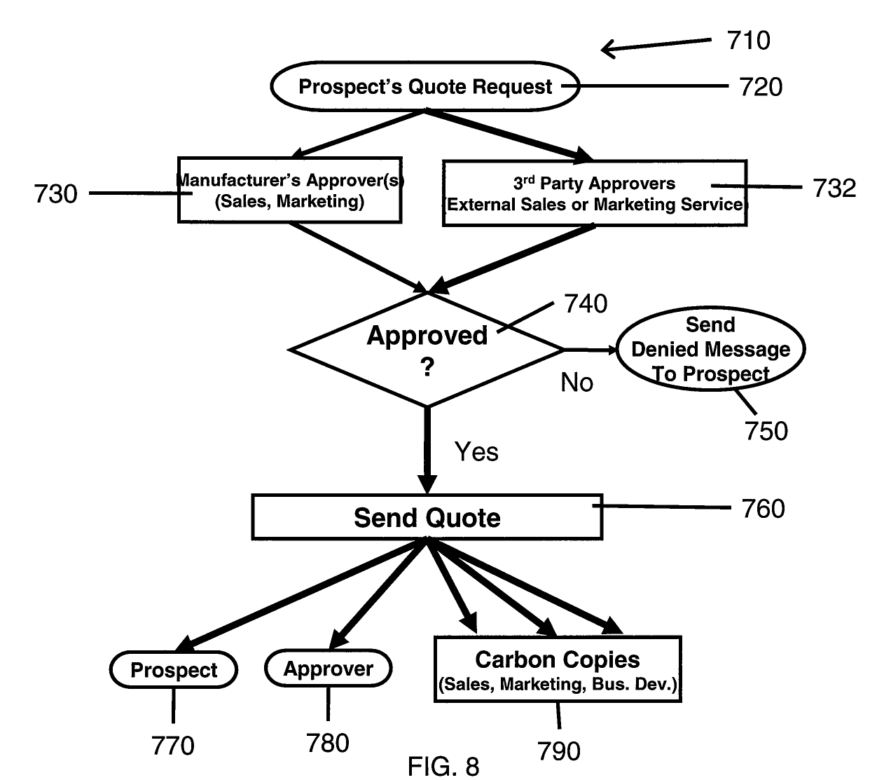

FIG. 8 is a flow diagram of how third parties can be used to manage quote approval and delivery, in accordance with an embodiment of the present invention. Because the approval process is flexible in that multiple “approvers”, even those outside the manufacturer, can be notified. This allows the manufacturer to “farm out” its marketing and quoting functions to a third party. In FIG. 8, an alternative process very similar to that described above in relation to FIG. 7 is shown that uses third-party approvers. In FIG. 8, the Quote Approval Process 710 from FIG. 7 is shown to include the same variety of steps and involvement of several different entities plus an additional step. In general, in FIG. 8, the quote approval process 710 ensures that only those Prospective Business Customers that are approved by the manufacturer's sales team (or any designated personnel) will receive the pricing information. In FIG. 8, the process flow for receiving and deciding on whether to approve a prospective customer's quote request is shown. Note that not all quote requests will require approval (see Smart Authorization description in FIG. 6), but for those that do the system is designed to handle the requests quickly.

In FIG. 8, the system receives (720) a prospective customer's request for a quote and, if necessary, forwards (730) the quote request to one or more pre-designated approval authorities, for example, but not limited to, the manufacturer's approver(s) (e.g., a sales manager, a marketing manager, and/or a business development manager) and/or one or more third-party approver(s) (e.g., a trusted agent and/or marketing service). If the request is denied (740), a message to that effect may be sent back to the prospective customer with additional information on what the prospective customer needs to do to obtain an actual quote. For example, this may only require that the user register with and be approved by the system to receive quotes. If the request is approved (740), the quote may be sent (760) to the prospective customer 770 with all of the necessary details and information for the prospective customer to finalize the purchase. In addition, the quote may be sent (760) to the person and/or entity that approved (740) the quote and copies may also be sent (760) to the other potential approvers that were not actually involved in the approval. For example, the quote also may be sent to the sales manager, the marketing manager, and/or the business development manager. In the event a quote is approved by mistake (regardless of the affiliation of the approver with the manufacturer) a recall function is available that will notify the prospective business customer that the quote is invalid.

In general, embodiments of the present invention may be implemented on standard and commonly available computer hardware and software. For example, the manufacturer's web site may be implemented however the manufacturer sees fit and that will support the link to the system pricing portal as implemented in the various embodiments of the present invention. The system pricing portal and system web engine are co-located and may be implemented using an internet attached system running Linux with Apache Web Server, MySQL database and PHP programming language. The current hardware setup is a single, Intel based Web Server with 4 GB of memory and mirrored 300 GB hard drives. The system as currently configured is sufficient for up to 43,200 quotes per 24 hour day (one every 2 seconds). The design is such that the addition of more servers scales the capacity linearly.

In accordance with an embodiment of the present invention, a system includes an electronic price quote generation system being adapted to receive a request to prepare a price quote on a product or a service offered by a seller; prepare a price quote for the product or the service; communicate the price quote for approval; receive approval of the price quote; and communicate the approved price quote in response to the request to prepare the price quote to a source of the request and to at least an approver of the price quote.

In accordance with an embodiment of the present invention, a method of providing electronic price quotes includes receiving a request to prepare a price quote on a product or service offered by a seller; preparing a price quote for the product or service; communicating the price quote for approval; receiving approval of the price quote; and communicating the approved price quote in response to the request to prepare the price quote to a source of the request and to at least an approver of the price quote.

In accordance with an embodiment of the present invention, a machine readable medium having stored thereon a plurality of machine executable instructions for performing a method of providing electronic price quotes, the method including: receiving a request to prepare a price quote on a product or service offered by a seller; preparing a price quote for the product or service; communicating the price quote for approval; receiving approval of the price quote; and communicating the approved price quote in response to the request to prepare the price quote to a source of the request and to at least an approver of the price quote.

While the present invention has been described in conjunction with a number of embodiments, the invention is not to be limited to the description of the embodiments contained herein, but rather is defined by the claims appended hereto and their equivalents. It is further evident that many alternatives, modifications, and variations would be or are apparent to those of ordinary skill in the applicable arts. Accordingly, all such alternatives, modifications, equivalents, and variations that are within the spirit and scope of this invention.

What is claimed is:

1. A system comprising:
an electronic price quote generation system being adapted to
receive a request to prepare a price quote on a product or a service offered by a seller;
prepare a price quote for the product or the service;
communicate the price quote for approval;
receive approval of the price quote; and
communicate the approved price quote in response to the request to prepare the price quote to a source of the request and to at least an approver of the price quote.

2. The system of claim 1 wherein the electronic price quote generation system is further adapted to approve the quote based on predetermined criteria independent of the seller.

3. The system of claim 2 wherein the predetermined criteria comprises at least one of:
a predetermined component price list;
a predetermined minimum system component configuration;
a selection of optional components; and
a predetermined discount associated with the source of the request.

4. The system of claim 2 wherein the electronic price quote generation system is further adapted to send the quote to a reseller; and receive approval from the reseller to send the quote to the source in response to the request.

5. The system of claim 4 wherein the predetermined criteria comprises at least one of:
a predetermined component price list;
a predetermined minimum system component configuration;
a selection of optional components; and
a predetermined discount associated with the source of the request.

6. The system of claim 1 wherein the prepare a price quote for the product or service comprises:
display the product or service with required and optional components listed;
receive selections of which and how many of each of the required and optional components to use to prepare the price quote; and
calculate the price quote based on a cost for and which and how many of each of the required and optional components to use.

7. The system of claim 6 wherein the prepare a price quote for the product or service further comprises:
if a predetermined discount is associated with the source of the request, apply the predetermined discount to reduce the calculated price quote.

8. The system of claim 1 further comprising:
a smart authorization component adapted to contain a specific pricing program for at least one customer to prepare the price quote, and
if any quote requests are received from the at least one customer, the smart authorization component to automatically approve the price quote.

9. The system of claim 1 further comprising:
a pricing programs function adapted to enable the system to automatically present a predetermined custom pricing schedule to the source of the request based on an identity of the source of the request.

10. A method of providing electronic price quotes, the method comprising:
receiving a request to prepare a price quote on a product or service offered by a seller;
preparing a price quote for the product or service;
communicating the price quote for approval;
receiving approval of the price quote; and
communicating the approved price quote in response to the request to prepare the price quote to a source of the request and to at least an approver of the price quote.

11. The method of claim 10 wherein the approving the quote comprises:
approving the quote based on predetermined criteria independent of the seller.

12. The method of claim 11 wherein the predetermined criteria comprises at least one of:
a predetermined component price list;
a predetermined minimum system component configuration;
a selection of optional components; and
a predetermined discount associated with the source of the request.

13. The method of claim 12 wherein the predetermined criteria comprises at least one of:
a predetermined component price list;
a predetermined minimum system component configuration;
a selection of optional components; and
a predetermined discount associated with the source of the request.

14. The method of claim 10 wherein the approving the quote comprises:
sending the quote to the seller; and
receiving approval from the seller to send the quote to the source of the request.

15. The method of claim 10 wherein the approving the quote comprises:
sending the quote to a reseller; and
receiving approval from the reseller to send the quote in response to the request.

16. The method of claim 10 wherein the preparing a price quote for the product or service comprises:
displaying the product or service with required and optional components listed;
receiving selections of which and how many of each of the required and optional components to use to prepare the price quote; and
calculating the price quote based on a cost for and which and how many of each of the required and optional components to use.

17. The method of claim 16 wherein the preparing a price quote for the product or service further comprises:
if a predetermined discount is associated with the source of the request, apply the predetermined discount to reduce the calculated price quote.

18. The method of claim 10 further comprising:
preparing the price quote using a specific pricing program associated with at least one customer; and
automatically approving the price quote, if the quote request was received from the at least one customer.

19. The method of claim 10 further comprising:
automatically presenting a predetermined custom pricing schedule to the source of the request based on an identity of the source of the request.

20. A machine readable medium having stored thereon a plurality of machine executable instructions for performing a method of providing electronic price quotes, the method comprising:
receiving a request to prepare a price quote on a product or service offered by a seller;
preparing a price quote for the product or service;
communicating the price quote for approval;
receiving approval of the price quote; and
communicating the approved price quote in response to the request to prepare the price quote to a source of the request and to at least an approver of the price quote.

21. The machine readable medium of claim 20 wherein the approving the quote comprises:
approving the quote based on predetermined criteria independent of the seller.

22. The machine readable medium of claim 21 wherein the predetermined criteria comprises at least one of:
a predetermined component price list;
a predetermined minimum system component configuration;
a selection of optional components; and
a predetermined discount associated with the source of the request.

23. The machine readable medium of claim 22 wherein the predetermined criteria comprises at least one of:
a predetermined component price list;
a predetermined minimum system component configuration;
a selection of optional components; and
a predetermined discount associated with the source of the request.

24. The machine readable medium of claim 20 wherein the approving the quote comprises:
sending the quote to the seller; and
receiving approval from the seller to send the quote to the source of the request.

25. The machine readable medium of claim 20 wherein the approving the quote comprises:
sending the quote to a reseller; and
receiving approval from the reseller to send the quote in response to the request.

26. The machine readable medium of claim 20 wherein the preparing a price quote for the product or service comprises:
displaying the product or service with required and optional components listed;
receiving selections of which and how many of each of the required and optional components to use to prepare the price quote; and
calculating the price quote based on a cost for and which and how many of each of the required and optional components to use.

27. The machine readable medium of claim 26 wherein the preparing a price quote for the product or service further comprises:
if a predetermined discount is associated with the source of the request, apply the predetermined discount to reduce the calculated price quote.

28. The machine readable medium of claim 20 further comprising:
preparing the price quote using a specific pricing program associated with at least one customer; and
automatically approving the price quote, if the quote request was received from the at least one customer.

29. The machine readable medium of claim 20 further comprising:
automatically presenting a predetermined custom pricing schedule to the source of the request based on an identity of the source of the request.
